(19) United States
(12) Patent Application Publication
(10) Pub. No.: US 2025/0253943 A1
(43) Pub. Date: Aug. 7, 2025

(54) Method For Checking An Optical Transmission Path In A Sensor System On The Basis Of An Optical Time-Domain Reflectometry Method, As Well As Sensor System And Vehicle

(71) Applicant: Volkswagen Aktiengesellschaft, Wolfsburg (DE)

(72) Inventors: Marc-Michael Meinecke, Sassenburg (DE); Heiko Gustav Kurz, Hannover (DE); Thomas Gisder, Wolfsburg (DE)

(73) Assignee: Volkswagen Aktiengesellschaft, Wolfsburg (DE)

(21) Appl. No.: 19/043,908

(22) Filed: Feb. 3, 2025

(30) Foreign Application Priority Data
Feb. 2, 2024 (DE) 10 2024 200 981.4

(51) Int. Cl. H04B 10/071; H04B 10/077

(52) U.S. Cl. CPC H04B 10/071; H04B 10/0775

(57) ABSTRACT

The disclosure relates to a method for checking a status of an optical transmission path in a sensor system, wherein the sensor system has a processor and at least one sensor, wherein the processor is switched over from a sensor operation mode, in which capturing of the environment can be performed with the sensor system, to a test operation mode, in which the at least one optical transmission path can be checked, In the test operation mode, an optical test signal is coupled into the optical transmission path, an item of status information regarding the status of the optical transmission path is determined by a test circuit of the sensor system on the basis of the coupled-in optical test signal, and the status of the optical transmission path is checked on the basis of the status information.

### CROSS-REFERENCE TO RELATED APPLICATIONS

This application claims priority to German Patent Application DE 10 2024 200 981.4, filed on Feb. 2, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for checking a status of at least one optical transmission path in a sensor system. Moreover, the disclosure relates to a sensor system for capturing the environment. Moreover, the disclosure relates to a vehicle having a corresponding sensor system.

### SUMMARY

A need exists to allow performing a transmission of optical signals within a sensor system such as, by way of example, a photonic radar system, more reliably.

The need is addressed by the subject matter of the independent claim(s). Embodiments of the invention are described in the dependent claims, the following description, and the drawings.

### BRIEF DESCRIPTION OF THE DRAWINGS

FIG. 1 shows a schematic representation of a vehicle having an example sensor system which has example antenna elements of an antenna array arranged in a distributed manner on the vehicle;

FIG. 2 shows a schematic representation of a block diagram of the example sensor system from FIG. 1;

FIG. 3 shows a schematic representation of a further embodiment of the radar system from FIG. 1;

FIG. 4 shows a further schematic representation of a block diagram of the example sensor system from FIG. 1, wherein the test circuit here is designed separately from the processor;

FIG. 5 shows a schematic view of an example optical test signal which is coupled into an optical transmission path to be checked by the example test circuit from the previous FIGS.; and

FIG. 6 shows a schematic representation of a flowchart for utilizing an example optical time-domain reflectometry method for calibration and for diagnosis of the sensor system.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one ordinary skill in the art that the invention may be practiced without these specific details. In other instances, well-known features have not been described in detail to avoid unnecessarily complicating the instant description.

Some embodiments of the disclosure relate to a method for checking a status of at least one optical transmission path in a sensor system, wherein:
for example, the sensor system has a processor and at least one sensor, and the processor is coupled to the sensor by means of the at least one optical transmission path,
for example, the processor is switched over from a sensor operation mode, in which environmental capturing of the surroundings can be performed with the sensor system, to a test operation mode, in which the at least one optical transmission path can be checked, with a control circuit,
for example in the test operation mode, an optical test signal is coupled into the at least one optical transmission path,
for example, an item of status information regarding the status of the at least one optical transmission path is determined by a test circuit of the sensor system on the basis of the coupled-in optical test signal, and
for example, the status of the at least one optical transmission path is checked on the basis of the status information.

In the context of this discussion, the term ‘sensor’ is understood to broadly refer to any sensor or sensor arrangement having one or more different or identical sensors.

The optical transmission of signals within the sensor system can in particular be improved by the proposed method. An error or a potentially occurring error during the transmission of an optical signal with the optical transmission path can be detected or, respectively recognized at an earlier stage by checking or, respectively testing the status of the optical transmission path such as, by way of example, of a fiber-optic cable (also referred to as ‘glass fiber’ herein).

For example, optical signals can be transmitted between the processor and the sensor by means of the optical transmission path. In this case, for example, control signals, with which the sensor can be controlled for the emission of transmission signals, can be optically transmitted. In this case, corresponding control signals can be transmitted optically by the processor to the sensor which can have transmitting elements or receiving elements, for example. Equally, corresponding receive signals such as radar signals from the sensor can be optically transmitted via corresponding optical transmission paths to the processor. A signal processing regarding the capturing of the environment can be performed with the processor, which is also referred to herein as ‘an electronic central computing unit’ or a ‘computing apparatus’.

In the context of this discussion, the terms ‘processor’ and ‘circuit’ are understood broadly to comprise hardware and hardware/software combinations to provide the respectively discussed functionality. The respective processor and/or circuit may be formed integrally with each other and/or with further components. For instance, the functionality of the processor and/or circuit may be provided by a microprocessor, microcontroller, FPGA, or the like, with corresponding programming. The programming may be provided as software or firmware, stored in a memory, or may be provided at least in part by dedicated (‘hard-wired’) circuitry.

The optical transmission path can be impaired during the transmission of optical signals due to imperfections, defects, damage and/or aging effects. The consequence of this can be that, for example, radar signals which have been received by the sensor arrive at the processor in a distorted manner, as a result of which the capturing of the environment and, consequently, the detection of potential collision objects can be error-prone. Likewise, in the event of an erroneous or, respectively functionally limited optical transmission path during the transmission of corresponding control signals to the sensor, the wrong sensors of the sensor system can be actuated, or corresponding signals are emitted in an insufficient manner, so that objects in the surroundings of the sensor system cannot be captured at all or can only be partially captured.

In order to be able to reduce these indicated negative effects of a defective optical transmission path, a check of the status of the optical transmission path is independently conducted by the sensor system with the proposed method. Most notably, some embodiments of the proposed method offer the benefit that no external measuring instruments are be used. Consequently, the sensor system, which is used in a motor vehicle or in another device, can continually conduct corresponding checks of the optical transmission path and, in particular, of all of the optical transmission paths present in the sensor system. Consequently, the optical transmission paths within the sensor system can be continuously checked for functionality during the application or, respectively during the use of the sensor system. This check can be performed by the test circuit of the sensor system, for example, cyclically, continually and/or automatically.

The processor of the sensor system can be switched to or, respectively placed in different operating modes with the control circuit, which can comprise one or more electrical and/or electronic components of the test circuit. In this case, if a check of the status of the optical transmission path is to be performed, the processor can be switched over from the sensor operation mode to the test operation mode. This can be performed, for example, continually or at regular intervals. When the sensor system is used in a motor vehicle, this check can, for example, be performed automatically when starting the motor vehicle.

In the sensor operation mode, the processor can control the sensor accordingly in order to capture the environment. In this case, the processor can transmit corresponding signals to the sensor and receive and further process received sensor signals from the sensor accordingly.

If a checking process of the status of the optical transmission path is to now be performed, the processor can initially be switched over to the test operation mode. In this test operation mode, the optical test signal can be produced by an optical tester such as an optical laser and can be coupled into the optical transmission path to be tested. In this case, a respective optical test signal can be coupled in for each optical transmission path of the sensor system to be tested or, respectively to be checked. By coupling in the in particular specific optical test signal, it can be checked how this optical test signal is transmitted with the optical transmission path. In this case, the propagation of the optical test signal within the optical transmission path can be taken into account or, respectively considered. As a consequence, the status and, consequently, the functionality of the optical transmission path can be checked or, respectively tested by means of the test circuit which can comprise electronic and/or electro-optical components. Conclusions can be drawn about the status of the at least one optical transmission path on the basis of the determined or, respectively established status information regarding the status of the optical transmission path, which is carried out by the test circuit. Consequently, a test, a check or an assessment of the status, in particular of a functional status, of the optical transmission path can be carried out. In this case, optical properties of the optical transmission path are, in particular, checked as to whether the optical transmission path is functional or functionally impaired in terms of the transmission of optical signals.

The checked status of the transmission path can be provided or, respectively made available, for example, to the processor and in particular to the sensor system.

The sensor system can, for example, be a photonic radar system. In this case, an active measurement of a fiber length of the optical transmission path can now be performed, with the aid of the proposed method, that is to say, with the aid of the checked status. This can be performed for calibrating or for detecting defects or for modifying the optical properties for diagnostic purposes. Consequently, an efficient check of the operational capability of the optical transmission path can be performed.

In some embodiments, it is provided that an error diagnosis regarding the at least one optical transmission path is performed on the basis of the status information, wherein a result of the error diagnosis performed is taken into account when checking the status of the at least one optical transmission path. The error diagnosis can be performed, for example, with the aid of the test circuit. Most notably, the error diagnosis can be performed continually. In this case, a check of the optical transmission path can be conducted at predefined or variable intervals in order to likewise be able to perform an error diagnosis continually or, respectively permanently. As a result, a possible or, respectively potential error within the optical transmission path can be ascertained at an early stage. As a result, repair measures can be conducted at an early stage or, if there are multiple optical transmission paths, the one erroneous transmission path is decommissioned or, respectively rendered inactive. On the basis of the status information, the test circuit can ascertain on the system side and in particular automatically whether the optical transmission path is error-prone in terms of an optical transmission or, respectively whether its function is restricted or, respectively erroneous. Most notably, the error diagnosis can be conducted when the sensor system is operating. This means that the sensor system does not have to be checked by a special test bench, service case external maintenance service provider. In particular, this is beneficial for the deployment of such a sensor system in the automotive sector. Consequently, a detection of defects within the optical transmission path of the sensor system can be performed at an early stage. Most notably, the test circuit offers the benefit that monitoring of the optical connections within the sensor system can be performed in terms of error diagnosis.

In some embodiments, it is provided that it is assessed by the system on the basis of the result of the error diagnosis performed whether the processor is switched back over from the test operation mode to the sensor operation mode and, if not, a new check of the at least one optical transmission path is performed. In other words, it can be ascertained with the result of the error diagnosis performed that an optical transmission can only be performed insufficiently with the aid of the optical transmission path. This means that the transmission of signals can be erroneous in terms of capturing the environment. In this case, it can be specified by the system, in particular by the test circuit and/or by the processor, that the processor is not initially switched back over from the test operation mode to the sensor operation mode. As a result, an erroneous capturing of the environment, which can lead to a dangerous situation when the sensor system is deployed in a vehicle, can be prevented. In this case, a new check of the optical transmission path can be conducted by the test circuit. If, in turn, it is subsequently ascertained that the optical transmission path is impaired in its function and in particular has a critical defect, a corresponding error message can subsequently be generated. In this case, most notably the processor, in particular the sensor system, can be informed that the at least one transmission path cannot currently be used. If the sensor system should have further optical transmission paths, these can be used as an alternative transmission if they could be successfully checked.

It would equally be conceivable that a fallback level is used in terms of the signal transmission within the sensor system, in the event of a critical status of the optical transmission path. To this end, the sensor system can, for example, have electrical or, respectively electronic transmission paths which could alternatively be used in this case.

In some embodiments, it is provided that a result of the check of the checked status of the at least one optical transmission path is provided to a control system of the processor, wherein at least one hardware component and/or at least one software component of the sensor system is/are configured by the control system on the basis of the result of the check. If it is ascertained with the result of the check of the status that the optical transmission path is impaired or, respectively error-prone in terms of its optical transmission characteristics, the corresponding at least one hardware component or multiple hardware components and/or a software component or multiple software components can be configured, adjusted or set accordingly so that the effects of the error-prone optical transmission path for the overall system can be reduced or, respectively minimized. For example, a power amplifier can be configured so that optical signals which are to be transmitted via the optical transmission path are amplified so that reliable transmission is possible or, respectively feasible. If, for example, it is ascertained with the result of the check that the optical transmission path has high optical losses in terms of the signal transmission, an amplifier power can be increased in terms of the transmission of optical signals via the optical transmission path, for example, by means of electronic adjustment of an amplifier.

It is equally conceivable that after an optical signal has been transmitted via the optical transmission path to the sensor, the received signal is subsequently processed and/or amplified, that is to say, within the sensor. Consequently, countermeasures can be taken here in the event of a functional impairment of the optical transmission path.

For example, a change or, respectively adjustment of system parameters of the sensor system can be made due to errors occurring, that is to say, in the event of a functional impairment of the optical transmission path. In addition or instead, an adjustment of sensors, such as antenna arrays, of the sensor can be made due to an error occurring within the optical transmission path and/or in the event of failures of individual components or, respectively parts of the optical transmission path.

In some embodiments, it is provided that the sensor system is calibrated on the basis of the result of the check of the checked status of the at least one optical transmission path. Consequently, if an erroneous and/or functionally impaired optical transmission path is ascertained, the sensor system can be calibrated, in particular automatically, in order to minimize possible negative effects of the optical transmission path on the operation of the sensor system. Consequently, the sensor system can be operated and deployed more efficiently. Consequently, a calibration or, respectively re-calibration of the sensor system can be conducted on the basis of the measurements or, respectively checks of the optical transmission paths of the sensor system. Consequently, the reliability and the robustness of the sensor system can be increased, since any errors or, respectively impairments of the at least one optical transmission path for the operation of the sensor system can be minimized since these errors are taken into account during the calibration.

In some embodiments, it is provided that calibration parameters and/or system parameters are determined on the basis of the result of the check of the checked status of the at least one optical transmission path, wherein the calibration parameters and/or system parameters are taken into account when calibrating the sensor system. Most notably, the test circuit, which can have an electronic evaluation unit, can be used in order to also establish parameters relevant for the calibration, in addition to a continual system monitoring of the optical transmission path of the sensor system. In this case, corresponding parameters, such as calibration parameters and/or system parameters, can be produced or, respectively calculated, for example, by reference to the established status information of the optical transmission path. That is to say that this calculation can be conducted by the test circuit and, for example, transmitted to the processor, so that the calibration of the sensor system or of individual subsystems of the sensor system can be performed based thereon.

For example, an online adjustment or, respectively an online update of the currently set calibration parameters and/or system parameters can be conducted. Consequently, depending on the current status or, respectively depending on the current situation, a suitable calibration of the sensor system or subsystem of the sensor system can be performed.

In some embodiments, it is provided that the status information regarding the status of the at least one optical transmission path is determined by the test circuit on the basis of an optical time-domain reflectometry method. Optical time-domain reflectometry (OTDR) is to be understood to be a method for establishing and analyzing run lengths and reflection characteristics of electromagnetic waves and signals in the wavelength range of light. For example, in the case of optical time-domain reflectometry, a laser pulse, such as the optical test signal, of the duration of 3 nsec to 20 μsec in a fiber-optic cable such as the optical transmission path, can be coupled in and the backscattered light can be measured over time.

A fiber length can be measured or, respectively established as an optical property of the optical transmission path with the aid of the optical time-domain reflectometry method. Consequently, an analysis of the respective optical properties of a respective optical transmission path of the sensor system can be performed.

In some embodiments, it is provided that the optical test signal is coupled into the at least one optical transmission path with an optical tester, wherein a backscattering of the coupled-in optical test signal is established over time by means of the optical time-domain reflectometry method. The optical tester can, for example, comprise an optical source such as a laser apparatus. In particular, a laser pulse or a test light pulse can be produced with the aid of the optical tester as an optical test signal and coupled into the optical transmission path. Subsequently, the backscattering or multiple backscatterings can be established or, respectively captured over time. The backscattering can be, for example, a backscattered light or, respectively return light signal. Consequently, the backscattering or multiple backscatterings can be captured, for example, over a predefined time. From this, losses on the transmission path and reflections of, for example, plug-in connectors within the transmission path as well as the attenuation of the optical transmission path can then be determined, for example, from the logarithmically plotted backscattering intensity. For example, the measured signal has a time dependence which can be converted into a spatial dependence via the group velocity. Consequently, a spatially resolved attenuation measurement can be realized.

In some embodiments, it is provided that a reflection characteristic, an attenuating property, an optical path length and/or optical losses of the at least one optical transmission path is/are determined as status information with the optical time-domain reflectometry method. In other words, the various optical properties which characterize the functionality of the optical transmission path can be established. Consequently, the optical properties of the optical transmission path can be checked or, respectively assessed with the aid of optical time-domain reflectometry. In other words, the fiber length of the optical transmission path can be established or, respectively measured with the aid of the optical time-domain reflectometry method.

This is then beneficial if, for example, the sensor system has multiple sensors or, respectively multiple sensor arrangements. When deployed, as an example, in the automotive sector, it can happen that the original position of a sensor is displaced, as a result of which the optical transmission path, which can be a fiber-optic cable here, has been elongated or, respectively widened. This can be ascertained by establishing the fiber length. This can, in turn, be taken into account in the case of a configuration of the sensor system. Likewise, corresponding error messages can be established so that the erroneous areas can be remedied.

Some embodiments of the disclosure relate to a sensor system for capturing the environment, having
a processor and at least one sensor, wherein the processor is coupled to the sensor by means of at least one optical transmission path,
a control circuit which is designed to switch over the processor from a sensor operation mode, in which an environmental capturing of the surroundings can be performed with the sensor system, to a test operation mode, in which the at least one optical transmission path can be checked,
an optical tester which is designed to couple an optical test signal into the at least one optical transmission path in the test operation mode,
a test circuit which is designed to determine an item of status information regarding a status of the at least one optical transmission path on the basis of the coupled-in optical test signal.

An efficient check of the optical transmission path or, respectively optical connections of the sensor system can be conducted by the proposed sensor system. Consequently, the sensor system can be operated more efficiently, on the one hand, and if an optical transmission path is error-prone or, respectively has a defect, this can be ascertained or, respectively detected at an earlier stage with the aid of the test circuit.

In particular, a method according to the teachings herein or an embodiment thereof can be executed or, respectively performed with the sensor system just outlined. To this end, the sensor system can have means in order to be able to execute a corresponding method.

The sensor system can be a photonic radar system for capturing the environment. In this case, one or more optical transmission paths, such as fiber-optic cables, are deployed in order to be able to transmit signals back and forth between the units of the sensor system. In order to make possible a safe and reliable transmission, the respective optical transmission paths can be checked or, respectively tested at regular intervals and in particular continually with the test circuit. Consequently, a defective or possibly future defective optical transmission path can be recognized at an earlier stage.

In particular, a transmitter (also referred to as ‘transmitting apparatus’ herein) and a receiver (also referred to as ‘receiving apparatus’ herein) and in particular the sensor on a single semiconductor chip can, for example, be integrated into a CMOS, SiM-CMOS, Bi-CMOS, hybrid-Bi-CMOS or with processes on photonic-electronic co-integrated chips. Consequently, a radar sensor device or the sensor system can be manufactured by mass production by means of standardized semiconductor processes, for example with the aid of the teachings herein.

For example, a frequency conversion of a terahertz carrier signal in the gigahertz frequency range can be performed with the aid of the sensor system after optical signal transmission and, conversely, reception of gigahertz signals can be performed with modulation on the terahertz carrier signal.

For example, the proposed sensor system can be used in motor vehicles. In some embodiments, the sensor system can be deployed, for example, in the case of at least partially autonomously operated motor vehicles, in particular in the case of fully autonomously operated motor vehicles. Secure sensing of the environment, which can be achieved by the sensor system, is beneficial for such an automated driving function. The environment or, respectively the surroundings can be captured by means of sensors such as radar, lidar and camera. These could be examples of the area of application of the radar sensor device. A comprehensive 360-degree three-dimensional capturing of the surroundings can be performed by the sensor system so that all of the static and dynamic objects can be captured.

The sensor system can be utilized as an alternative to lidar in some embodiments, since lidar in particular plays a major role in the redundant, robust capturing of the environment, since this type of sensor can measure distances and angles more precisely in the capturing of the environment and can also be deployed for classification.

For example, the sensor system can be deployed, for example, in the case of at least partially autonomously operated motor vehicles, but in particular also in the case of fully autonomously operated motor vehicles. However, sensing the environment reliably is indispensable in order to make possible such an automated driving function. The environment or, respectively the surroundings is/are captured with the aid of sensors such as radar, lidar or camera. A comprehensive 360-degree three-dimensional capturing of the surroundings is particularly important so that all of the static and dynamic objects can be captured. The sensor system can be used to this end. In particular, lidar plays a major role in the redundant, robust capturing of the environment, since this type of sensor can measure distances more precisely in the capturing of the environment and can also be deployed for classification. Admittedly, these lidar sensors are cost-intensive and complex in their construction. In particular, a 360-degree three-dimensional capturing of the environment is problematic, since either many smaller individual sensors are necessary in order to guarantee this, which, as a general rule, work with many individual light sources and detector elements, or large lidar sensors are installed. Furthermore, lidar sensors are susceptible to weather influences such as rain, fog or direct sunlight. To this end, the sensor system can remedy this.

Radar sensors or, respectively radar sensor devices have likewise become established in automotive engineering and supply data in all weather conditions in a reliable and fail-safe manner. Even poor visibility conditions such as, for example, rain, fog, snow, dust or darkness hardly influence the sensing reliability thereof. According to the prior art, the resolving power thereof has been limited thus far; in particular, series-produced radars which are deployed are merely designed with a resolution of an angle of approximately 2 degrees. In order to meet the requirements for an increased level of automation in automotive engineering with safe driving functions, it is provided that the radar sensor device supplies three-dimensional images having a high angular resolution in the range of 0.1 degrees and below, having a low sensitivity with respect to interferences from the surroundings thereof. This is not achieved with the conventional radar technology according to the prior art since the resolving power of such systems would be too low. The sensor system according to the teachings herein is beneficial in such situations.

The sensor system can be designed as a photonic radar sensor device which increases the resolving power by co-integrating electronic and photonic components in a single semiconductor chip. The tracking of a FMCW signal as well as the entire signal processing and signal evaluation are performed by the central station. Each transmitting and receiving component has an electronic-photonic co-integrated circuit, a so-called EPIC chip. Silicon photonics technology is used for the co-integration. This makes possible the monolithic integration of photonic components, high-frequency electronics and digital electronics together on a chip. The technical innovation of such a system lies in the signal transmission of gigahertz signals by means of the optical carrier signal in the terahertz frequency range. A central station, which can also be described as a central electronic processor, produces an optical carrier frequency in terahertz. On this, the transmitted signal is modulated at one-eighth of the radar frequency and the optical fiber is transmitted to the antenna chips. On these, the frequency is multiplied, so that the radar radiation can be output by the antenna chips. The signal detection happens in the reverse process. All of the data are processed on the central station.

However, such an embodiment is very complex in the implementation of gigahertz electronics at chip level. In particular, the frequency multiplication which takes place on the chip following detection by a photodiode is technically challenging and poses a high challenge in terms of gigahertz signal production with a high signal-to-noise ratio and the lowest possible jitter. Thus, the gigahertz signal has to be stabilized in an elaborate manner in further steps. Moreover, gigahertz electronics are cost intensive. Furthermore, high power requirements are placed on the optical carrier, in particular the laser, since a lot of optical power is required in order to produce a highly accurate gigahertz signal, which makes single-phase ring circuits difficult to realize for a radar array having many distributed radar semiconductor chips. Furthermore, two photonic-electronic semiconductor chips are, in particular, required for a respective transmitting and receiving channel, which leads to further costs. The problems just mentioned are solved at least partially, in particular completely, by the sensor system according to the teachings herein.

In particular, the teachings herein utilize the fact that the radiation of the laser apparatus, which can in particular also be designed as a CW laser, is coupled in, by means of an optical interface, in a photonic semiconductor. This can be the optical transmission signal or, respectively a carrier signal of the CW laser.

The production of the FMCW signal as well as the entire signal processing and evaluation are performed by a central station, for example the processor. Each transmitting and receiving component consists of an electronic-photonic co-integrated chip (so-called “EPIC chip”). Silicon photonics technology is used for the co-integration. This makes possible the monolithic integration of photonic components, high-frequency electronics and digital electronics together on a chip (“electronic-photonic co-integration”). The technical innovation of such a system lies in the signal transmission of GHz signals by means of an optical carrier signal in the THz frequency range. A central station produces an optical carrier frequency (THz). On this, the signal to be transmitted is modulated at ⅛ of the radar frequency and is transmitted via optical fiber to the antenna chips. On these, the frequency is increased eightfold, so that the radar radiation can be output by the antenna chips. The signal detection happens in the reverse process. All of the data are processed on the central station.

The principle of the electronic-photonic co-integration in a chip, with silicon-on-insulator regions for the photonic components and bulk silicon regions for the electronic circuits is a globally unique technology. For example, at high data rates, a high signal quality with low parasitic interference can be realized therewith. The linking of the RF circuits for the radar antennas, including frequency multipliers, to the optical transceiver can be implemented without additional wire or flip chip bonding. In addition, chips can already be optically and electrically tested at wafer level, as a result of which a high yield can be achieved in the further modular construction. With this technology, extremely compact form factors can be realized and, associated therewith, a high relevance for the application of optical technologies on the basis of silicon photonics in the automotive industry.

The obstacle to the productive deployment of optical fibers lies in the lack of scalability of previously available technologies. This scalability to large volumes is made possible by the technology for highly integrated production of electronic-photonic integrated circuits. The result is a significant cost reduction in construction technology and a more efficient cost structure. From data solutions, there exist the development of center comprehensive libraries for electronic and photonic components for data transmission at high bandwidths, to which recourse is had in the project.

In some embodiments, it is provided that the control circuit is coupled to a control system of the processor, wherein the control system is designed to control the control circuit to switch over from the sensor operation mode to the test operation mode or from the test operation mode to the sensor operation mode. The control circuit, which can, for example, be an integral part of the test circuit, can be connected to the control system by optical connection, electrical connection and/or digital connection. Consequently, the control system of the processor can, for example, specify when and which optical transmission path is to be checked or, respectively to be tested. For example, an electrical control signal can be generated with the aid of the control system and transmitted to the control circuit. The operating mode of the processor and, consequently, of the sensor system can be switched over or, respectively set accordingly with the aid of the control circuit which can be a “control interface”. Consequently, measurements or, respectively checking processes can be conducted independently and, consequently, actively by the sensor system without external measuring equipment in order to perform the quality or, respectively functionality of the optical transmission paths in the sensor system. Consequently, the sensor system can be deployed in many more ways. As a result, the robustness and the longevity of the sensor system can be increased, since corresponding imperfections in the optical transmission path can, in particular, be ascertained at an early stage and can be reacted to at an early stage.

Alternatively, the control circuit can likewise be designed to run the processor in a third operating mode, that is to say, not in the sensor operation mode and test operation mode. This third operating mode can be a multiplex operating mode. In this case, a parallel operation of the check of individual transmission paths and the regular transmission operation or, respectively environmental capturing operation of the sensor system can be performed by means of a multiplexing method. In this case, signal and message transmission can be performed, in which multiple signals can be transmitted in a combined or, respectively bundled manner and simultaneously via a medium such as the optical transmission path. Consequently, the optical test signal can be transmitted with the optical transmission path, in particular simultaneously or, respectively at the same time as a control or sensor signal with the optical transmission path.

In some embodiments, it is provided that the test circuit has an optical time-domain reflectometer (also referred as to ‘reflectometry unit’ herein) for the determining status information. As a result, as already discussed multiple times regarding this in the introduction, a plurality of optical properties or, respectively optical parameters of the optical transmission path can be established or, respectively determined as status information. In other words, an OTDR (optical time-domain reflectometry) system can be integrated into the processor and/or into the sensor system for continual system monitoring and to establish the parameters relevant for the calibration. The respective optical path length of the optical transmission path can be used or, respectively utilized with the aid of the optical time-domain reflectometry unit in order to calibrate the, in particular photonic, radar system. Consequently, an integration of semiconductor circuits for optical time-domain reflectometry, for error analysis and for calibration of photonic radar systems can be achieved or, respectively created.

In some embodiments, it is provided that the control circuit and the optical time-domain reflectometry unit are integrated on a common component or module and this component is designed to be spatially and/or physically separate from the processor.

By dividing the components for checking the optical transmission paths and the processor, the sensor system can be deployed more efficiently depending on the application case, since the respective components can be adjusted or, respectively mounted accordingly depending on the installation space specifications. In particular, the component, if it contains the units for the corresponding check of the optical transmission paths, can be provided as a retrofittable component for sensor systems.

Alternatively, the control circuit and the optical time-domain reflectometer can be integrated in the processor.

Consequently, the sensor system can be arranged or, respectively installed accordingly depending on the space requirements or, respectively installation space availability. Consequently, a system for checking optical transmission paths can be integrated into the processor in the simplest way possible. Consequently, the processor and, consequently, the sensor system can be operated more efficiently and reliably.

In some embodiments, it is provided that the optical tester is additionally designed, in the sensor operation mode, to produce an optical transmission signal which can be transmitted to the sensor for capturing the environment. In other words, the optical tester serves to make possible the regular operation of the sensor system, namely the transmission of optical transmission signals to the sensors of the sensor. If the test operation mode is now set, the optical tester, which can be a laser apparatus, can be used in order to produce the optical test signal and to couple it into the optical transmission path. Consequently, an additional optical tester for checking the optical transmission path can be dispensed with here. Consequently, installation space and in particular costs can be saved here.

As an alternative, the test circuit can have a standalone or, respectively separate optical tester such as a laser. This would be a benefit in particular in the case of a retrofittable test circuit or, respectively in the case of the component.

Some embodiments of the disclosure relate to a vehicle having a sensor system according to the teachings herein or one or more embodiments.

For example, the vehicle can be a manually operated vehicle, a partially autonomously operated vehicle or a fully autonomously operated vehicle. In other words, the vehicle can be a highly automated vehicle.

In particular, the vehicle can be a motor vehicle such as a passenger car or truck.

In the embodiments described herein, the described components of the embodiments each represent individual features that are to be considered independent of one another, in the combination as shown or described, and in combinations other than shown or described. In addition, the described embodiments can also be supplemented by features other than those described.

Configurations of the method or, respectively of the methods are to be regarded as configurations of the sensor system and of the vehicle. The sensor system as well as the vehicle have objective features which make it possible for the method or an configuration thereof to be performed.

For application cases or application situations which can occur in the case of the method and which are not explicitly described here, it can be provided that an error message and/or a prompt to enter user feedback is/are issued according to the method and/or a standard setting and/or a predetermined initial state is/are set.

The disclosure also includes embodiments of the sensor system according to the teachings herein and the vehicle according to the teachings herein, which have features as they have already been described in connection with the embodiments of the methods according to the teachings herein. For this reason, the corresponding embodiments of the sensor system and of the vehicle are not described once again here.

Reference will now be made to the drawings in which the various elements of embodiments will be given numerical designations and in which further embodiments will be discussed. Specific references to components, process steps, and other elements are not intended to be limiting. Further, it is understood that like parts bear the same or similar reference numerals when referring to alternate FIGS. The FIGS. are schematic and not necessarily to scale.

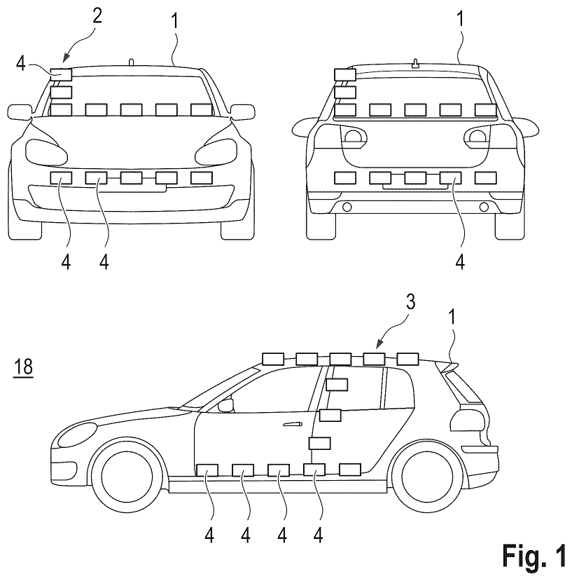

FIG. 1 shows various schematic views (front view, rear view, side view) of a vehicle 1, which can be a motor vehicle. The vehicle 1 includes, for example, a sensor system 2.

The sensor system 2 can, for example, be a radar system or an environment sensor system of the vehicle 1. To this end, the sensor system 2 can be communicatively networked, for example, with one or more driver assistance systems or other vehicle systems. For example, the sensor system 2 can be a radar sensor or a lidar sensor or another type of sensor, in particular for vehicles. In addition to the deployment of the sensor system 2 in the vehicle 1, it can likewise be deployed in systems external to the vehicle.

The sensor system 2 has multiple sensors 4, for example. It is likewise conceivable that the sensor system has at least one antenna array 3 or multiple antenna arrays. The antenna array 3 can, in turn, be designed from a plurality of antenna elements such as, for example, the sensors 4. The antenna elements can be arranged on the vehicle 1, distributed at a distance from one another, in particular for the 360-degree capturing of the environment.

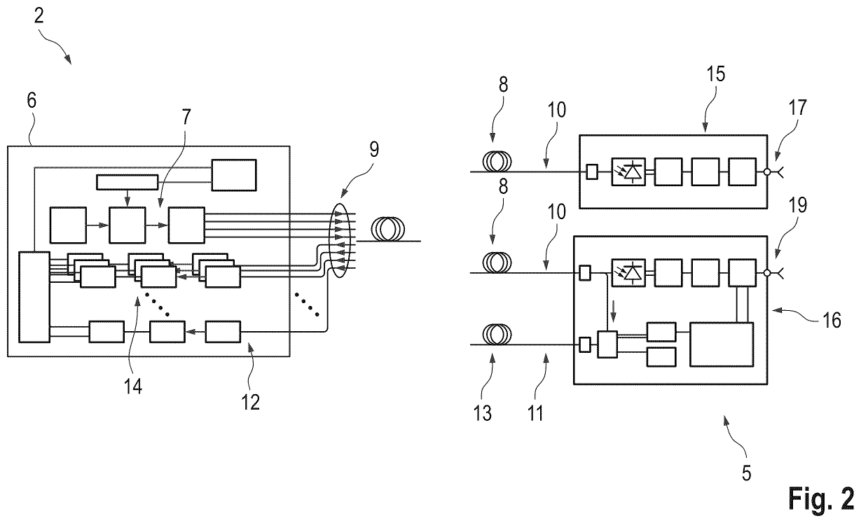

FIG. 2 shows a conceivable embodiment of the sensor system 2. The sensor system 2 can have at least one sensor 5 and a central electronic processor 6. The sensor 5 and the central electronic processor 6 can, for example, be separate and physically isolated units. The sensor 5 can, for example, have the at least one antenna array 3.

The central electronic processor 6 is a central unit. For example, the central electronic processor 6 can produce an electrical control signal, with which an optical tester 7 such as a laser apparatus can be actuated or, respectively controlled. The optical tester 7 can, for example, be a CW laser. An optical transmission signal or, respectively a carrier signal 8 can be produced with the aid of the optical tester 7. The optical transmission signal 8 can in particular be described as an optical carrier signal in the terahertz frequency range. The central electronic processor 6 can, for example, produce the optical carrier frequency. On this optical carrier frequency, the signal to be transmitted is modulated at one-eighth of a radar frequency and is, for example, transmitted to the sensor 5. In this way, an eightfold increase in frequency can take place. Signals in the gigahertz frequency range can, in turn, be received and transmitted to the central electronic processor 6 with the aid of the sensor 5.

The central electronic processor 6 can, for example, be coupled in each case via at least one optical transmission path 9, such as a glass fiber, to an optical input 10 and an optical output 11 of the sensor 5. Consequently, a bidirectional signal transmission can be carried out between the central electronic processor 6 and the sensor device 5.

The central electronic processor 6 can, for example, be described as an electronic evaluation unit.

Moreover, the central electronic processor 6 can have an optical receiving unit 12 which is adapted to receive an optical output signal 13 which is provided with the optical output 11 of the sensor 5. Consequently, the central electronic processor 6 can be coupled to the sensor 5 via optical fiber or electronic interface such as, by way of example, Ethernet. In particular, multiple radar sensor devices or antenna arrays can be coupled to the central electronic processor 6. For example, the central electronic processor 6 can have a processing unit 14 or, respectively a computing unit with which the received optical output signal can be processed. Consequently, a signal acquisition and a subsequent data processing of the received output signal 11 can be performed.

In particular, the central electronic processor 6 can have or, respectively provide all of the necessary control signals, data processing signals, components and interfaces.

In addition to the optical input 10 and the optical output 11, the sensor 5 can, for example, have at least one transmitting apparatus 15 or transmitting antenna and at least one receiving apparatus 16 or receiving antenna. Consequently, the sensor 5 has a receiving component and/or transmitting component (i.e., a receiver and/or transmitter). In particular, the transmitting apparatus 15 and the receiving apparatus 16 can be integrated on one and the same chip. It is likewise conceivable that these are located on various semiconductor chips.

An electrical radar emitted signal 17, which is based on the optical transmission signal 8, can be emitted into the surroundings 18 of the vehicle 1 with the aid of the transmitting apparatus 15. Consequently, a corresponding radar signal 17 can be emitted as a function of the optical transmission signal 8. If this signal 17 is now reflected in the surroundings 18 by objects such as, for example, road users, roads, trees or other objects, an electrical receive signal 19 corresponding to the electrical radar emitted signal 17 and reflected in the surroundings 18 can be received.

The transmitting apparatus 15 can, for example, have at least one antenna or, respectively one antenna unit or multiple antennas for the emission.

The radar emitted signal 17 or, respectively electrical emitted signal emitted and the receive signal 19 received can, for example, be in the terahertz frequency range or gigahertz frequency range. Consequently, a frequency conversion of a terahertz carrier signal, in particular of a transmission signal 8, into the gigahertz frequency range for emission can be performed with the aid of the sensor system 2. Conversely, the reception of gigahertz signals can be performed with modulation on the terahertz carrier signal. For example, the transmitting apparatus 15 can have at least one grating coupler and a photodiode for the emission. The receiving apparatus 16 can, for example, have two jitter couplers, a photodiode and a modulator for the reception.

The signal can be modulated at ⅛ of the radar frequency and transmitted via optical fiber to the antenna chips or, respectively antenna elements with the sensor system 2. On these, the frequency is specifically increased eightfold, so that the radar radiation can be output by the antenna chips. The signal detection optionally happens in the reverse process. All of the data can be processed on the central station.

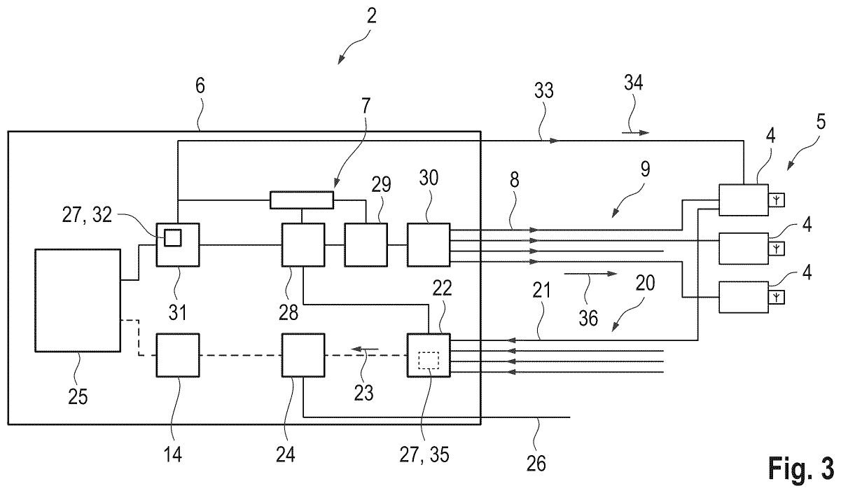

FIG. 3 shows a further conceivable embodiment of the sensor system 2. Here, the sensor system likewise has the processor 6 which can have another configuration or, respectively equipment in this embodiment.

The sensor system 2 specifically has multiple transmitting/receiving units such as, for example, the antenna elements, which can, e.g., be arranged in a distributed manner on the vehicle 1, in particular for capturing the environment.

The transmitting/receiving units or, respectively antenna elements can be utilized both for transmitting and for emitting or, respectively for receiving signals. Consequently, the transmitting/receiving units are combined units for emitting and for receiving signals.

For example, such a transmitting/receiving unit can be described as a transmitting and receiving component. This can be described or, respectively designed from an electronic-photonic co-integrated chip (so-called “EPIC chip”). The processor 6, which can be described as a central unit, can likewise be designed from an electronic-photonic co-integrated chip. In particular, the processor 6 is a physically and/or spatially separate unit from the transmitting/receiving units.

The processor 6 can, for example, have the optical tester 7 or, respectively a laser. In particular, the optical tester 7 can be designed as an optical source or as a CW laser. The optical transmission signal 8 or, respectively a carrier signal can be produced and consequently provided with the aid of the optical unit. The optical transmission signal 8 can for example be designed as an optical carrier signal in the terahertz frequency range. The processor 6 can, e.g., produce the optical carrier frequency. At this optical carrier frequency, the signal to be transmitted can be modulated at one-eighth of a radar frequency and transmitted, e.g., to the transmitting/receiving units. In this way, the frequency can be multiplied. Signals in the gigahertz frequency range can, in turn, be received with the aid of the transmitting/receiving units.

The processor 6 can, for example, be connected to a respective transmitting/receiving unit via an optical transmission path 9. Signals, in particular optical signals, can be transmitted via the optical transmission path 9 from the processor 6 to the individual transmitting/receiving units. In order to, in turn, be able to send received signals from the transmitting/receiving units back to the processor 6 for evaluation or, respectively signal processing, a respective transmitting/receiving unit can be optically coupled to the processor 6 via an optical return channel 20.

The electrical emitted signal 17 can be emitted, in particular into the surroundings 18, with at least one transmitting/receiving unit. Likewise, an electrical receive signal 19 corresponding to the electrical emitted signal 17 can, in turn, be received with the transmitting/receiving unit. For example, the emitted signal 17 can be reflected by an object in the surroundings 18 of the vehicle 1 and, consequently, received as an electrical receive signal 19. The receive signal 19, which can, e.g., be described as a radar signal, can be transferred or, respectively transmitted to the processor 6 for evaluation or, respectively signal processing. To this end, the electrical receive signal can be converted by means of the transmitting/receiving unit into an optical receive signal 21. For example, this can be transmitted via the return channel 9 to the processor 6. The optical receive signal 21 can, in turn, be converted into an electrical signal 23 by means of an optically-electric converter unit 22 or, respectively detector unit of the processor 6. The unit 22 can, e.g., be used for optical detection. To this end, the conversion can, e.g., be carried out by homodyne detection or heterodyne detection. Moreover, the unit 22 can conduct a phase measurement and/or a phase length measurement.

A digitization can, in turn, be subsequently carried out by means of a digital interface 24. In this case, an analog-to-digital conversion can most notably be carried out. To this end, the digital interface 24 can have an analog-to-digital converter. A processing unit 14 can subsequently be arranged. A signal processing, in particular in the case of a “low-level signal”, can, e.g., be utilized with this. For example, a Fast Fourier Transform (“FFT”) can be used to this end. The digitized, processed electrical signal 23 can subsequently be made available to a control system 25, such as a CPU, ECU or GPU, of the processor 6. In this case, an item of radar information or, respectively environmental information contained in the electrical signal 23, can in particular be evaluated or, respectively processed. Moreover, an electrical return channel 26 can be provided, which provides a back coupling from at least one of the transmitting/receiving units to the processor 6 and in particular to the digital interface 24.

In order to be able to capture the environment or, respectively detect the sensor system 2 in the most stable and low-noise manner possible, the optical transmission signal 8 can be adjusted by means of a frequency synthesis or, respectively gigahertz frequency synthesis. To this end, the processor 6 can have a synthesis unit. To this end, the optical transmission signal 8 can be fed or, respectively transmitted to the synthesis unit. For example, before the optical transmission signal 8 is made available to the synthesis unit, a modulation will be conducted. To this end, a modulator or, respectively modulation unit 28 can, e.g., be provided. This can be designed, e.g., as an arbitrary generator or arbitrary waveform generator (AWG). After the synthesis unit, e.g., an optical control unit 29 as well as an optical switch or, respectively distributor 30 can be provided in the processor 6 in order to be able to make correspondingly processed signals from the synthesis unit available to the transmitting/receiving units via the glass fiber 9. Moreover, a control unit 31 can be controlled by the evaluation unit 25 in order to be able to monitor or, respectively control the production of the optical transmission signal in particular. Moreover, a control unit or, respectively a feedback loop 32 can be provided.

Moreover, the processor 6 is electrically connected to the transmitting/receiving units by means of an electrical transmission path 33. An electrical control signal 34 can be transmitted via this electrical transmission path 33 for controlling or, respectively for actuating the transmitting/receiving units or, respectively antenna elements.

In particular, the processor 6 serves to produce an optical carrier signal, the optical transmission signal 8, and to feed this into a gigahertz frequency synthesis unit, e.g. the synthesis unit. The synthesized gigahertz signal can be transmitted to the transmitting/receiving units in the optical spectral range via fiber, that is to say, the glass fiber 9, so that, e.g., a 77 gigahertz signal can be output or, respectively emitted by transmitting/receiving units. The signal detection can, in turn, be carried out in the reverse process. All of the data can be processed in the processor 6.

The configurations of the processor 6 in FIG. 2 and FIG. 3 can be combined as desired.

In the case of the sensor system 2, which can be a photonic radar system, knowledge of optical path lengths of the optical transmission path 9 within the sensor system 2 is beneficial or, respectively necessary for the calibration of the sensor system 2. Moreover, the optical transmission path 9, which is sensitive to damage, can have defects. Thus, the monitoring of the optical connections within the sensor system 2, which is carried out with the at least one optical transmission path 9 or multiple such optical transmission paths, is to be performed, most notably, in order to be able to conduct an error diagnosis. Consequently, it is necessary to check or, respectively to monitor the optical transmission paths within the sensor system 2 for their functionality, that is to say, in their transmission reliability.

In this regard, in order to be able to efficiently check a status of the optical transmission path 9, in particular during the deployment of the sensor system 2, the sensor system 2 has its own systems or, respectively units for checking the optical connections. To this end, the sensor system 2 has a test circuit 27. The test circuit, which can be an electronic system, can be designed from multiple components, as shown in FIG. 3 as an example. In particular, the test circuit 27 can have a control circuit 32 and an optical time-domain reflectometry unit 35. As shown as an example in the figure, the control circuit 32 can be integrated in the control unit 31. The optical time-domain reflectometry unit 35 can, in turn, be integrated with the optically electric converter unit 22.

The control circuit 32 is designed to switch over the processor 6 between a sensor operation mode, in which the environmental capturing of the surroundings 18 can be performed, and a test operation mode, in which the optical transmission path 9 can be checked. Consequently, the control circuit 32 can be a “control interface” with which it is possible to switch back and forth between a test operation mode and a sensor operation mode, depending on whether the environment is to be captured or the optical connections are to be checked. An optical test signal 36, which can be a laser pulse, can be coupled into the optical transmission path 9 for testing the status of the optical transmission path 9, if the processor is switched over to the test operation mode. In this case, a respective optical test signal can be coupled into a respective optical transmission path which is to be checked in terms of the respective functionality.

The test circuit 27 can, most notably, determine or, respectively establish an item of status information, such as a measurement result, of the status of the at least one optical transmission path 9 on the basis of an optical time-domain reflectometry method, with the aid of the optical time-domain reflectometry unit 35. In this case, a backscattering or backscatterings such as, by way of example, a backscattering light or, respectively a reflection light, of the coupled-in test signal can be established or, respectively measured over time by means of the optical time-domain reflectometry unit with the optical time-domain reflectometry method. In other words, the optical test signal is coupled in and it is accordingly, in this case, in particular continually measured what losses the optical transmission path has. Consequently, it can be ascertained here what fiber length or, respectively optical path length the optical transmission path 9 has, in particular currently. Most notably, a reflection characteristic, an attenuating property, an optical path length and/or optical losses of the optical transmission path can be established or, respectively determined as status information.

The information or, respectively the status information can subsequently be made available to the processor 6 and, for example, the control system 25. In this case, the status of the optical transmission 9 path can, consequently, be assessed or, respectively analyzed in order to be able to derive corresponding measures therefrom. In this case, a readjustment or, respectively a configuration of the sensor system can be conducted. It is likewise conceivable that corresponding error messages are generated and made available to an external monitoring unit or to a user of the sensor system 2. It is equally conceivable that the optical transmission path 9 which is not currently suitable for the transmission of optical signals is decommissioned or, respectively rendered inactive. In this case, other optical transmission paths or electrical transmission paths of the sensor system 2 can be used as an alternative transmission option.

The control circuit 32 is for example communicatively coupled or, respectively connected to the control system 35 for switching over between the operating modes, so that a corresponding signal exchange can take place here. The production of the optical test signal 36 can, for example, additionally be carried out by the optical tester 7 of the sensor system 2. Consequently, the test operation mode can be switched or, respectively switched over here by the control circuit 32, on the one hand, and the control circuit 32 can additionally actuate the optical tester 7 accordingly in order to be able to generate the optical test signal 36. Consequently, a compact construction of the processor 6 can be achieved in this case.

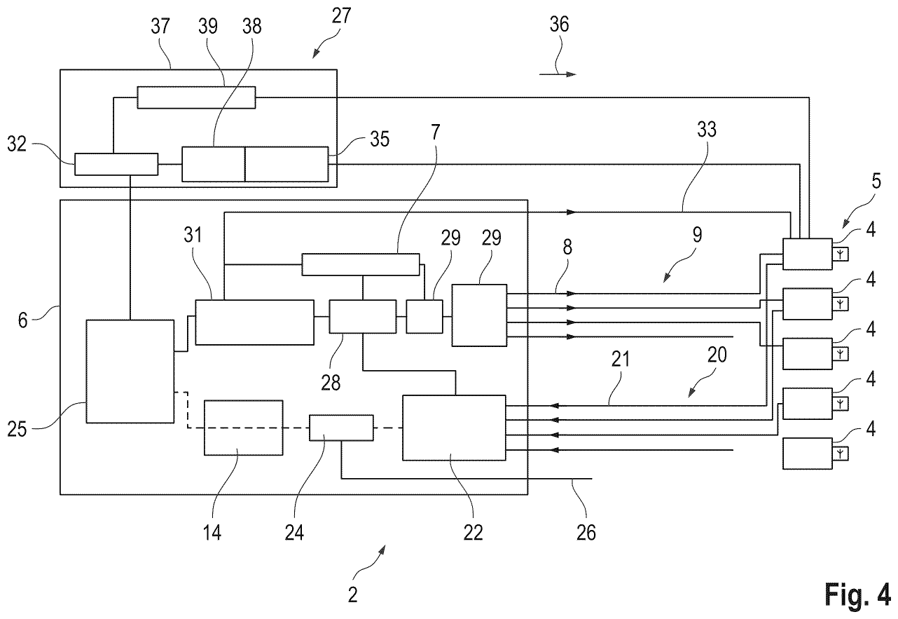

A further embodiment of the sensor system 2 is shown in FIG. 4. In this case, unlike the explanations in FIG. 3, the test circuit 27 here is designed as a common component 37. Consequently, the test circuit 27 is designed and in particular arranged separately or, respectively in an isolated manner from the processor 6. Consequently, contrary to the multi-part test circuit 27 in FIG. 3, the test circuit 27 here is now designed in one part. Here, this can be an benefit for certain application cases in which the processor 6 and the test circuit 27 have to be installed separately from one another due to space limitations or, respectively installation space limitations. Moreover, it is conceivable that the test circuit 27 can be made available in this variant as a retrofittable system for sensor systems.

In this case, the control system 25 can now, in turn, be connected to the control circuit 32 via, for example, electrical or, respectively electronic connections, in FIG. 3. The control circuit 32 can be connected to the time-domain reflectometry unit 35. An analog-to-digital converter 38 or, respectively a “digital interface” can be arranged between the control circuit 32 and the optical time-domain reflectometry unit 35 for the electrical-optical conversion. In this variant, the test circuit 27 has its own optical tester 39 like a laser. The optical test signal 36 can be produced with this optical tester 39 and coupled into the checking optical transmission path 9. To this end, a coupling-in can be carried out with corresponding optical cables, for example, by means of coupling elements.

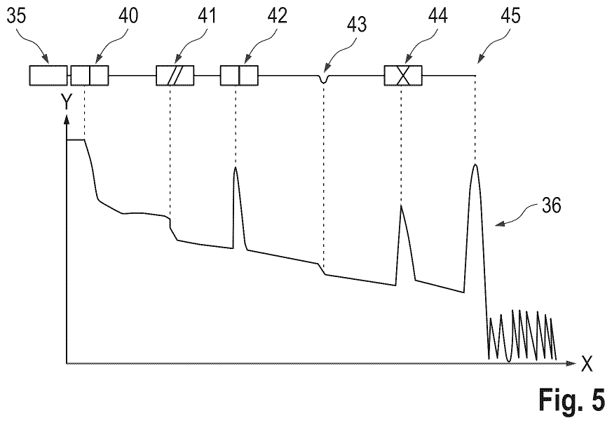

FIG. 5 shows, as an example, how the coupled-in test signal 36 can be impaired by losses.

In this case, the fiber length in meters is illustrated for example on the x-axis. The attenuation in dB is plotted with the y axis.

As an example, it can be seen here that the optical time-domain reflectometry unit 35 is initially shown at the zero point. This serves to measure the fiber length by refractometric measurement. Most notably, losses occur due to imperfections and connectors which can be recognized in the case of the measurement method. After the coupling-in, losses can already occur due to a connector 40. Subsequently, further losses or, respectively attenuations of the signal can, for example, occur due to a “splice” 41. Losses arise, in turn, due to a further connector 42, which can, in turn, be subsequently further attenuated by a bend 43 of the optical transmission path. For example, a mechanical splice 44 can subsequently be present, which increases the losses again. Finally, the signal only has an attenuated or, respectively minimized power or, respectively signal strength at the fiber end 45.

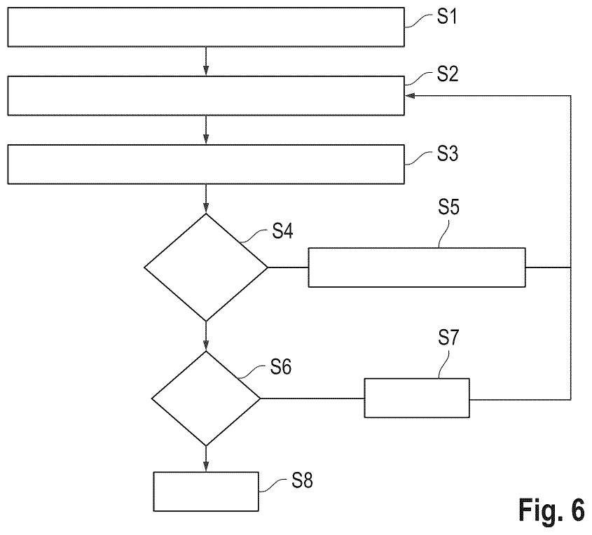

The utilization of the optical time-domain reflectometry (OTDR) method for calibration and for diagnosis of a photonic radar system, such as of the sensor system 2, is explained in the following FIG. 6 in an exemplary flowchart.

In a first step S1, the sensor system 2 can be integrated on and/or in the vehicle 1. This can be a complete, partial or virtually coherent photonic radar system.

In an optional subsequent step, S2, calibration data can be loaded or, respectively retrieved. Said data can be retrieved by a storage unit in the sensor system 2.

Subsequently, in an optional step, S3, the processor 6 can be placed in the test operation mode and the optical test signal can be coupled into the optical transmission path 9. In this case, optical properties of the optical transmission path 9 such as optical losses, defects, bends within the path or the path length or, respectively fiber length of the optical transmission path 9 can, in turn, be established or, respectively measured with the aid of the optical time-domain reflectometry unit 35. Said information or, respectively measurement results can, for example, be provided as status information, so that the status of the optical transmission path 9 can be assessed.

In an optional subsequent step S4, defects, damage, functional impairments or other errors of the optical transmission path 9 can be checked due to the status information or, respectively the checked status of the optical transmission path 9. In other words, it is checked here whether the optical transmission path 9 is functional in terms of the transmission of optical signals. For example, an error diagnosis can be performed here.

If it is ascertained during step S4 that the optical transmission path 9 is error-prone, an adjustment of hardware components and/or software components of the sensor system 2 can be conducted in a subsequent optional step S5. In this case, adjustments can, for example, be made to the sensor 5 and, in particular, the antenna array 3. For example, an exchange or, respectively a changeover of certain components can be conducted. Following this optional step S5, the process can, in turn, be continued with step S2.

If it is ascertained during step S4 that the optical transmission path 9 is functional, it can be checked in an optional step S6 whether the calibration of the sensor system is up to date. If this is not the case, an initial calibration or, respectively a calibration of the sensor system 2 can be conducted in an optional step S7 on the basis of the checked status of the optical transmission path 9. Following step S7, the process can subsequently be continued with step S2.

If it is ascertained during step S6 that the calibration is up-to-date and in order, the sensor system 2 can be used or, respectively reused for capturing the environment in an optional step S8.

### LIST OF REFERENCE NUMERALS

1 Vehicle
2 Sensor system
3 Antenna array
4 Sensors
5 Sensor
6 Central electronic processor
7 Optical tester
8 Optical transmission signal
9 Optical transmission path
10 Optical input
11 Optical output
12 Receiving unit
13 Output signal
14 Processing unit
15 Transmitting apparatus
16 Receiving apparatus
17 Electrical emitted signal
18 Surroundings
19 Electrical receive signal
20 Return channel
21 Optical receive signal
22 Optical-electrical converter unit
23 Electrical signal
24 Digital interface
25 Control system
26 Electrical return channel
27 Test circuit
28 Modulator
29 Optical control unit
30 Optical distributor
31 Control unit
32 Control circuit
33 Electrical transmission path
34 Electrical control signal
35 Optical time-domain reflectometry unit
36 Optical test signal
37 Further optical tester
38 Analog-to-digital converter
39 Optical tester/component
40 Connector
41 Splice
42 Connector
43 Bend
44 Mechanical splice
45 Fiber
S1 to S8 Steps

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A method for checking a status of at least one optical transmission path in a sensor system, wherein the sensor system has a processor and at least one sensor, and the processor is coupled to the sensor using the at least one optical transmission path, the method comprising:
switching the processor by a control circuit from a sensor operation mode, in which environmental capturing of the surroundings can be performed with the sensor system, to a test operation mode, in which the at least one optical transmission path can be checked, wherein in the test operation mode, an optical test signal is coupled into the at least one optical transmission path;
determining an item of status information regarding the status of the at least one optical transmission path by a test circuit of the sensor system on the basis of the coupled-in optical test signal; and
checking the status of the at least one optical transmission path on the basis of the status information.

2. The method of claim 1, comprising performing an error diagnosis regarding the at least one optical transmission path on the basis of the status information, wherein a result of the error diagnosis performed is taken into account when checking the status of the at least one optical transmission path.

3. The method of claim 2, comprising assessing, by the system, on the basis of the result of the error diagnosis performed, whether the processor is switched back over from the test operation mode to the sensor operation mode and, if not, a new check of the at least one optical transmission path is performed.

4. The method of claim 1, comprising providing a result of the check of the checked status of the at least one optical transmission path to a control system of the processor, wherein at least one hardware component and/or at least one software component of the sensor system is/are configured by the control system on the basis of the result of the check.

5. The method of claim 4, comprising calibrating the sensor system on the basis of the result of the check of the checked status of the at least one optical transmission path.

6. The method of claim 5, comprising determining calibration parameters and/or system parameters on the basis of the result of the check of the checked status of the at least one optical transmission path, wherein the calibration parameters and/or system parameters are taken into account when calibrating the sensor system.

7. The method of claim 1, wherein the status information regarding the status of the at least one optical transmission path is determined by the test circuit on the basis of an optical time-domain reflectometry method.

8. The method of claim 7, wherein the optical test signal is coupled into the at least one optical transmission path with an optical tester, wherein a backscattering of the coupled-in optical test signal is established over time using the optical time-domain reflectometry method.

9. The method of claim 7, comprising determining one or more of a reflection characteristic, an attenuating property, an optical path length, and optical losses of the at least one optical transmission path as status information with the optical time-domain reflectometry method.

10. A sensor system for capturing the environment, having:
a processor and at least one sensor, wherein the processor is coupled to the sensor using at least one optical transmission path;
a control circuit which is configured to switch over the processor from a sensor operation mode, in which an environmental capturing of the surroundings can be performed with the sensor system, to a test operation mode, in which the at least one optical transmission path can be checked;
an optical tester which is configured to couple an optical test signal into the at least one optical transmission path in the test operation mode;
a test circuit which is configured to determine an item of status information regarding a status of the at least one optical transmission path on the basis of the coupled-in optical test signal.

11. The sensor system of claim 10, wherein the control circuit is coupled to a control system of the processor, wherein the control system is configured to control the control circuit to switch over from the sensor operation mode to the test operation mode or from the test operation mode to the sensor operation mode.

12. The sensor system of claim 10, wherein the test circuit has an optical time-domain reflectometry unit for determining the status information.

13. The sensor system of claim 12, wherein
the control circuit and the optical time-domain reflectometry unit are integrated on a common component and this component is configured to be spatially and/or physically separate from the processor; or
the control circuit and the optical time-domain reflectometry unit are integrated in the processor.

14. The sensor system of claim 10, wherein the optical tester is additionally designed to, in the sensor operation mode, generate an optical transmission signal which can be transmitted to the sensor for capturing the environment.

15. A vehicle having a sensor system of claim 10.

16. The sensor system of claim 10, comprising performing an error diagnosis regarding the at least one optical transmission path on the basis of the status information, wherein a result of the error diagnosis performed is taken into account when checking the status of the at least one optical transmission path.

17. The sensor system of claim 10, comprising assessing, by the system, on the basis of the result of the error diagnosis performed, whether the processor is switched back over from the test operation mode to the sensor operation mode and, if not, a new check of the at least one optical transmission path is performed.

18. The sensor system of claim 10, comprising providing a result of the check of the checked status of the at least one optical transmission path to a control system of the processor, wherein at least one hardware component and/or at least one software component of the sensor system is/are configured by the control system on the basis of the result of the check.

19. The sensor system of claim 18, comprising calibrating the sensor system on the basis of the result of the check of the checked status of the at least one optical transmission path.

20. The sensor system of claim 19, comprising determining calibration parameters and/or system parameters on the basis of the result of the check of the checked status of the at least one optical transmission path, wherein the calibration parameters and/or system parameters are taken into account when calibrating the sensor system.
